(19) United States
(12) Patent Application Publication
(10) Pub. No.: US 2025/0341233 A1
(43) Pub. Date: Nov. 6, 2025

(54) NEEDLE CAGE AND PLANETARY TRANSMISSION HAVING A NEEDLE CAGE

(71) Applicant: WITTENSTEIN SE, Igersheim (DE)

(72) Inventors: Michael Schmidt, Reichenberg (DE); Franziska Lux, Würzburg (DE)

(73) Assignee: WITTENSTEIN SE, Igersheim (DE)

(21) Appl. No.: 19/199,625

(22) Filed: May 6, 2025

(30) Foreign Application Priority Data
May 6, 2024 (DE) 102024112678.7

(51) Int. Cl. F16C 33/46; F16H 1/28; F16H 57/08

(52) U.S. Cl. CPC F16C 33/467; F16H 57/08; F16H 1/28; F16H 2057/085

(57) ABSTRACT

Needle cage for guiding needle rollers of a needle roller bearing arrangement of a planet gear of a planetary transmission on a planet gear carrier, the needle cage having a flange, wherein the needle cage is embodied in such a way that a thrust washer can be arranged on the needle cage radially on the outside; and planetary transmission having a planet gear mounted on a planet gear carrier, a needle cage for guiding needle rollers of a needle roller bearing arrangement of the planet gear, wherein a region between the planet gear carrier and the needle cage is free of thrust washers.

### BACKGROUND OF THE INVENTION

The disclosure relates to a needle cage and to a planetary transmission having a needle cage for the bearing arrangement of a planet gear of the planetary transmission.

### PRIOR ART

Planetary transmissions having a needle cage are known from the prior art. By way of example, DE 10 2022 111 073 A1 describes a needle cage having a lubricant guide structure.

However, the prior art with needle cages has disadvantages with regard to the maximum load-bearing capacity of the bearing arrangement compared to a full-complement bearing arrangement. When replacing the full-complement bearing arrangement with needle rings consisting of needle rollers and a needle cage, load-bearing capacity is lost. A needle ring usually has a significantly lower load rating than a full-complement bearing arrangement in the same structural space. However, the needle ring offers advantages in terms of wear behavior, efficiency and mountability.

### SUMMARY OF THE INVENTION

The object of the invention is to specify a needle cage and a planetary transmission that are improved compared to the prior art. In particular, the intention is to specify a planetary transmission having a needle cage that has the highest possible load-bearing capacity of the bearing arrangement in a small structural space.

The object is achieved by a needle cage and by a planetary transmission as disclosed herein.

One aspect relates to a needle cage for guiding needle rollers of a needle roller bearing arrangement of a planet gear of a planetary transmission on a planet gear carrier, the needle cage comprising a flange, wherein the needle cage is embodied in such a way that a thrust washer can be arranged on the needle cage radially on the outside.

Another aspect relates to a planetary transmission having a planet gear mounted on a planet gear carrier, and a needle cage for guiding needle rollers of a needle roller bearing arrangement of the planet gear, wherein a region between the planet gear carrier and the needle cage is free of thrust washers.

Where enumeration is given with “or” below, what is meant herein, unless specified otherwise, is “and/or”.

In typical embodiments, the planetary transmission comprises a plurality of planet gears that are arranged around a sun gear and engage therein. Typically, the plurality of planet gears are mounted on a planet gear carrier. The planet gear carrier can be embodied as an input drive of the planetary transmission, as an output drive of the planetary transmission, or can be of fixed design. The planetary transmission can be embodied as a stepped planetary transmission having stepped planet gears, each of which has two toothing systems.

Typically, the planet gear is mounted on the planet gear carrier with a needle roller bearing arrangement. The needle roller bearing arrangement comprises, in typical embodiments, a needle cage for guiding a plurality of needle rollers. In typical embodiments, the needle cage is of single-row construction. In particular, all the needle rollers of the needle roller bearing arrangement, in the circumferential direction, are arranged in a plane perpendicular to an axis of rotation of the needle cage. In embodiments, the needle cage is of double-row construction. In particular, a first number of needle rollers is arranged in a first row and a second number of needle rollers is arranged in a second row. The first number of needle rollers is arranged in a first plane perpendicular to the axis of the needle cage. The second number of needle rollers is arranged in a second plane perpendicular to the axis of the needle cage. Typically, the first plane and the second plane are at least substantially parallel to one another. In particular, “substantially” in this context and if expedient herein in general means that substantially parallel planes, for example the first plane and the second plane, intersect at an angle of at most 5°, at most 2° or at most 1°.

Typically, the needle cage receives in the radial interior a planet pin for fastening the planet gear to the planet gear carrier. The needle cage is arranged in a bore of the planet gear.

The needle cage typically comprises a plurality of webs, which in each case connect flanges arranged on the end face. Needle rollers are inserted between the webs. Typically, a web width, especially at the narrowest point of the web in the circumferential direction, is less than 50%, or 45%, and greater than 15%, or greater than 20%, of the diameter of a needle roller. By way of example, when a diameter of a needle roller is 3.5 mm, the web width is between 0.6 mm and 1.7 mm. A high number of needle rollers over the circumference of the needle cage advantageously allows a high load-bearing force of the needle roller bearing arrangement to be achieved. Typically, the axial width of the needle rollers in a single-row design corresponds at least substantially to the width of the gear wheels of the planet gear. In particular, in this context or in other relative terms herein, “at least substantially” means at least 85%, at least 90% or at least 95% and at most 102%, at most 101% or at most 100% of the width of the gear wheels of the planet gear.

Typically, a region between the planet gear carrier and the needle cage is free of thrust washers. In particular, there is no other component between at least one part of the needle cage and the planet gear carrier. In particular, in the axial direction, no thrust washer is arranged between the planet gear carrier and the needle cage, in particular a flange of the needle cage. In other words, the needle cage is arranged at least in parts directly adjacent to the planet gear carrier. In particular, in embodiments, the needle cage is in contact with the planet gear carrier. In embodiments, an end face of the needle cage is arranged flush with a cheek of the planet gear carrier. Dispensing with a thrust washer in the region of the needle cage can advantageously make it possible to make better use of an available structural space. In particular, an axial width of the webs, and thus of the needle rollers, can be increased given the same structural space. This enables in particular a higher load-bearing capacity of the bearing arrangement.

In typical embodiments, the planetary transmission comprises a thrust washer. The thrust washer spaces the planet gear relative to the planet gear carrier and serves to support the planet gear on a cheek of the planet gear carrier. In particular, the thrust washer prevents direct contact between the planet gear and the planet gear carrier. The planet gear and the planet gear carrier may have different rotation speeds. Preventing direct contact makes it possible to avoid increased friction or wear.

Typically, the thrust washer is arranged on the needle cage radially on the outside. In typical embodiments, the thrust washer is arranged on the flange of the needle cage radially on the outside. In particular, the thrust washer sits on the needle Cage. The thrust washer is typically arranged at least substantially parallel to an end face of the needle cage. In typical embodiments, the thrust washer is arranged in a centered manner relative to an axis of the needle cage. In particular, the thrust washer is arranged or embodied so as to be rotationally symmetrical with respect to the axis of the needle cage.

In typical embodiments, the thrust washer and a flange of the needle cage overlap axially. Typically, the thrust washer and the needle rollers do not overlap axially.

In a preferred embodiment, the thrust washer is arranged axially at least substantially flush with an end face of the needle cage. This advantageously enables a good use of the structural space for the needle cage. “Substantially” in this case encompasses a slight protrusion of the thrust washer beyond the end face of the needle cage in the region of tolerance deviations.

In embodiments, an axial spacing of the thrust washer from the cheek of the planet gear carrier is less than an axial spacing of an end face of the needle cage from the cheek of the planet gear carrier. In other words, the thrust washer protrudes beyond the end face of the needle cage. In particular, the axial spacing of the thrust washer from the cheek of the planet gear carrier is less than 99%, less than 98% or less than 95% of the axial spacing of the end face of the needle cage from the cheek of the planet gear carrier. A protrusion of the thrust washer can advantageously reduce a sliding contact of the needle cage with the cheek of the planet gear carrier, and thus wear on the needle cage.

In typical embodiments, the thrust washer is arranged at least substantially flush with an inner edge of a flange of the needle cage. In embodiments, the thrust washer is arranged flush with an inner edge of the flange and with an outer edge of the flange, in other words with the end face of the needle cage. In embodiments, a width of the flange corresponds to a width of the thrust washer. In embodiments, the width of the thrust washer is greater than the width of the flange. With a wider thrust washer, it is advantageously possible to support the planet gear relative to the cheek of the planet gear carrier and thus in particular to reduce the wear on the needle cage. In embodiments, the width of the thrust washer may be smaller than the flange of the needle cage.

In typical embodiments, the width of the thrust washer is at least 0.3 mm or at least 0.5 mm and at most 1.2 mm or at most 1.5 mm, and preferably at least substantially 1 mm. In typical embodiments, the width of the flange is at least 0.5 mm or at least 0.8 mm and at most 1.2 mm or at most 1.5 mm, and preferably at least substantially 1 mm.

Typically, the needle cage has a radial shoulder as the axial contact surface of the thrust washer. In typical embodiments, the radial shoulder comprises a radial offset between the webs and flange of the needle cage. In particular, the maximum radial distance of the webs to the axis of the needle cage is greater than the maximum radial distance of the flange to the axis of the needle cage.

In typical embodiments, the webs comprise radial elevations, in particular at the axial borders of the webs. Typically, the radial elevations are embodied in such a way that they are suitable for receiving the needle rollers, in particular by clipping in or plugging in. In particular due to their greater extent in the circumferential direction, radial elevations of the webs can advantageously define the position of the needle rollers and in particular prevent a loss of the needle rollers. Typically, the radial shoulder can be embodied by way of the radial elevations.

For the purpose of receiving the needle rollers, the webs are concave in the circumferential direction and, at their narrowest point, have a width that is smaller than half the diameter of a needle roller. In preferred embodiments, the minimum web width is between 10% and 50% of the roller diameter. This allows for a high number of needle rollers over the circumference and thus represents another measure to increase the load-bearing capacity of the needle roller bearing arrangement.

Typically, the webs have cutouts in an axially central region, in particular for lubricant supply or as a lubricant reservoir. In embodiments, the radial elevations at the axial borders of the webs define the cutouts in the axially central region.

Typically, the radial shoulder, as the axial contact surface, defines a position of the thrust washer. In particular, movement of the thrust washer on the flange can be advantageously avoided.

In embodiments, the axial contact surface is formed by a shoulder in the region of the flange, especially if the width of the thrust plate is narrower than the flange.

In preferred embodiments, a radial inner diameter of the thrust washer is smaller than a radial outer diameter of a contact surface of the thrust washer on the needle cage. In other words, there is an interference fit between the contact surface of the thrust washer and the thrust washer. In embodiments, the radial inner diameter of the thrust washer is larger than the radial outer diameter of the contact surface of the thrust washer on the needle cage. In other words, there is a clearance fit between the contact surface of the thrust washer and the thrust washer. In particular, the rotation speed of the needle cage and the thrust washers is typically at least substantially the same.

In typical embodiments, the thrust washer is made of a hardened metal. A hardened metal design reduces wear on the thrust washer. The hardened metal design can advantageously result in uniform wear on the thrust washer and a longer service life of the needle roller bearing arrangement. In embodiments, the thrust washer is made of a plastic.

Typically, the needle cage is preferably made of a plastic. In typical embodiments, the needle cage is manufactured in an injection molding method or in an additive primary forming method. In embodiments, the needle cage is made of a metal. Typically, the needle cage has a one-part form.

In typical embodiments, the needle cage and the thrust washer have a one-part form. In particular, the thrust washer is fixedly connected to the needle cage. Typically, the thrust washer is fixedly integrally molded on the needle cage, in particular by an injection molding method or by an additive primary forming method. A one-part form of the needle cage with the thrust washer can advantageously facilitate the installation of the needle cage in the planetary transmission. Typically, the thrust washer lies against the planet gear and, in particular, not against the needle rollers. This can reduce wear on the thrust washer.

In typical embodiments, the needle roller bearing arrangement comprises a second thrust washer. Typically, the second thrust washer has a multi-part, in particular two-part, form with the needle cage. In particular, the thrust washer typically has a one-part form with the needle cage and the second thrust washer has a multi-part, for example two-part, form with the needle cage.

In typical embodiments, the needle roller bearing arrangement comprises a needle cage with a first thrust washer and a second thrust washer, wherein the first and the second thrust washer have a multi-part form with the needle cage. This leads to a simple construction of the needle cage or simple producibility, especially in an injection molding method.

In typical embodiments, the planetary transmission, in particular a stepped planetary transmission, has a second needle cage for a double-row needle roller bearing arrangement. Typically, the needle cage and the second needle cage are arranged axially next to one another. In typical embodiments, the needle cage and the second needle cage have a one-part form. Typically, the thrust washer and the needle cage and the second needle cage have a one-part form. A one-part form of the needle cage, the second needle cage and the thrust washer advantageously reduces the total number of parts and can facilitate assembly.

In typical embodiments, the needle cage and the second needle cage have a multi-part, in particular two-part, form. Typically, the needle cage and the second needle cage each have a one-part form with in each case one thrust washer. In other words, the needle cage has a one-part form with a first thrust washer and the second needle cage has a one-part form with a second thrust washer.

The invention makes it possible to achieve a planetary transmission having an improved planet gear bearing arrangement. The invention permits an improved use of a given structural space for the bearing arrangement by way of a greater needle roller length. In particular, in typical embodiments, the axial region between the needle cage and the planet gear carrier may be free of thrust washers and exclusively the flange of the needle cage may space the needle rollers from the cheek of the planet gear carrier. This allows for, by way of example, longer needle rollers, typically at least 1 mm or at most 2 mm longer; in particular, the length of the needle rollers can at least substantially correspond to the width of the planet gear. Due to a very small web width in the circumferential direction, a large number of needle rollers can be arranged. Thus, a higher load-bearing force of the bearing arrangement can be achieved. One-part forms of the needle cage and thrust washer have a small number of parts and allow for simple assembly. Multi-part forms of the needle cage and thrust washer allow for simpler production, especially in an injection molding method.

The invention makes it possible to extend the service life of the planetary transmission, in particular by reducing the friction and wear in the planetary transmission.

### BRIEF DESCRIPTION OF THE DRAWINGS

The invention will be explained in more detail below on the basis of the appended drawings, wherein the figures schematically show:

FIG. 1 a needle cage according to the invention having thrust washers in a longitudinal section;

FIG. 2a a further embodiment of the invention in a longitudinal section;

FIG. 2b the embodiment of FIG. 2a in a further illustration;

FIG. 2c a further embodiment of a needle cage;

FIG. 3a a further embodiment of the invention in a longitudinal section;

FIG. 3b the embodiment of FIG. 3a in a further illustration.

### DETAILED DESCRIPTION

Typical exemplary embodiments will be described below on the basis of the figures, wherein the invention is not limited to the exemplary embodiments. Rather, the scope of the invention is determined by the claims. In the description of the embodiments, under some circumstances, the same reference signs are used for the same or similar parts in different figures and for different embodiments, in order to make the description clearer. However, this does not mean that corresponding parts of the invention are limited to the variants illustrated in the embodiments. In some instances, features which have already been described in connection with other figures are not described again for the sake of clarity. In some instances, features which are illustrated multiple times in a figure are only labeled with a reference sign once.

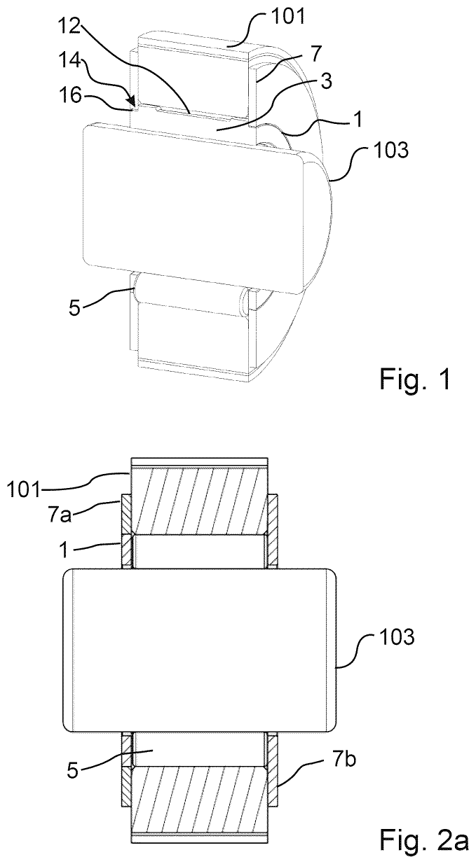

FIG. 1 shows a needle cage 1 according to the invention of a planetary transmission having a planet gear 101 mounted on a planet pin 103 in a planet gear carrier (not shown). The planet gear 101 is mounted rotatably on the planet pin 103 by means of a needle roller bearing arrangement. The needle cage 1 comprises a plurality of webs 3, with only one web 3 being visible in the illustration in FIG. 1, and lateral flanges 16, which are connected by the webs. The needle rollers 5 are arranged axially between the flanges. The flanges are circumferential around the axis of rotation and thus serve as an axial stop for the needle rollers 5. In the circumferential direction, the needle rollers 5 are in each case spaced apart from one another by a web 3. In the illustration in FIG. 1, only one needle roller 5 is visible.

The axial length of the needle rollers 5 corresponds substantially to the axial width of the planet gear 101.

The webs 3 of the needle cage 1 each have a cutout 12. The cutout 12 extends axially over approximately ⅔ of the axial length of the web 3. The cutout 12 allows a lubricant to be supplied to the needle rollers 5. At the axial ends of the webs 3, the webs each have a radial shoulder 14. The radial shoulder 14 comprises substantially a right-angled step. In other words, a first face of the radial shoulder 14 is at least substantially parallel to a radial axis of the needle cage 1, and a second face of the radial shoulder 14 is at least substantially parallel to an axial axis of the needle cage 1. The second face of the radial shoulder 14 is arranged in the region of the flange 16 of the needle cage 1.

In the embodiment of FIG. 1, the planetary transmission has two thrust washers 7. Each of the thrust washers 7 is arranged on the needle cage 1 radially on the outside. In particular, the thrust washers 7 are arranged on the needle cage 1 in a centered manner. The thrust washers 7 have an at least substantially hollow-cylindrical shape. The axes of the thrust washers 7 are at least substantially parallel to the axes of the needle cage 1. Each of the thrust washers 7 overlaps axially with in each case a flange 16 of the needle cage 1. The radial shoulder 14 serves as the contact surface for the thrust washer 7. In particular, the thrust washer 7 lies against the first face of the radial shoulder in the axial direction and sits radially on the outside of the second face. In particular, the thrust washer sits axially flush on the flange 16 of the needle cage 1. The flange 16 can in this case advantageously center the thrust washer 7. In the illustration in FIG. 1, each of the thrust washers 7 is arranged axially flush with a respective end face of the needle cage 1. Each of the thrust washers 7 is arranged flush with an inner edge of the flange 16, in other words flush with the first face of the radial shoulder 14. In the embodiment of FIG. 1, needle rollers 5 can run against the thrust washers 7.

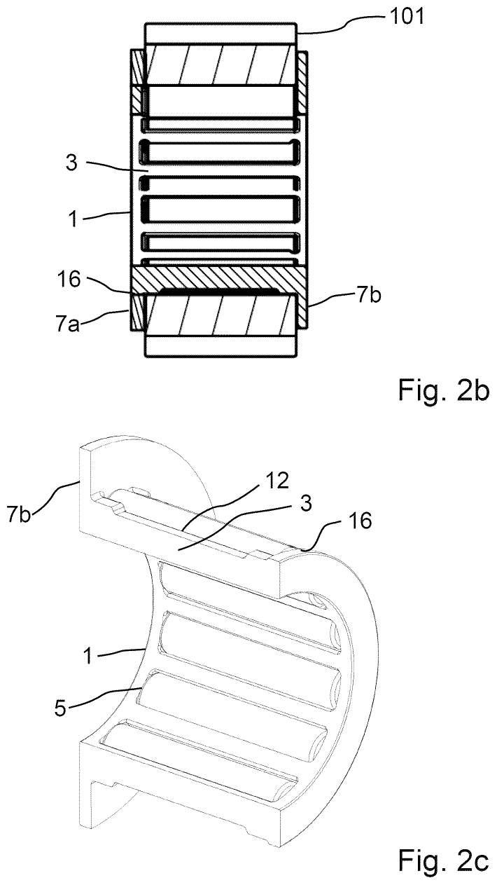

FIG. 2a shows an alternative embodiment of the invention. The planetary transmission having a planet gear 101 and a planet pin 103 comprises a first thrust washer 7a, which lies flush on the second contact surface of the needle cage 1, analogously to the embodiment of FIG. 1. The thrust washer terminates substantially axially flush with an inner side and an outer side of the flange 16. The planetary transmission further comprises a second thrust washer 7b (arranged on the right in the illustration in FIG. 2a), which has a one-part form with the needle cage 1. The needle cage 1 and the second thrust washer 7b form a physical unit. An outer radius of the first thrust washer 7a corresponds to an outer radius of the second thrust washer 7b. The second thrust washer 7b axially terminates the needle cage 1; in other words, the second thrust washer 7b forms one of the end faces of the needle cage 1.

In FIG. 2b, the needle cage 1 of the embodiment of FIG. 2a is shown without a planet pin. FIG. 2b further shows an angled section, such that the upper part of the illustration of the needle cage 1 shows a needle roller in section and the lower part of the illustration shows a web in section. The needle cage 1 comprises a plurality of webs 3. The needle cage 1 has a one-part form with the second thrust washer 7b. On one of the end faces of the needle cage, the first thrust washer 7a lies flush on the flange 16 of the needle cage.

FIG. 2c shows an alternative embodiment of the needle cage 1 of the embodiment of FIGS. 2a and 2b, which differ by the geometric dimensions of the needle cage and arrangement of the thrust washer.

In the exemplary embodiments of FIGS. 2a and 2b, the thrust washers do not overlap radially with the needle rollers 5.

In the exemplary embodiment of FIG. 2c, the thrust washers 7b overlap radially with the needle rollers 5.

In all exemplary embodiments according to FIGS. 2a to 2c, the needle rollers 5 extend radially inward beyond the needle cage 1. In contrast to the illustrations in FIGS. 2a and 2b, the needle cage 1 in FIG. 2c is shown without the first thrust washer, which can be arranged on the flange 16 of the needle cage, for example by means of an interference fit. A plurality of needle rollers 5 are inserted in the needle cage 1. The needle rollers 5 are limited to a rotational movement about their axis of rotation and the planetary shaft by the webs 3 of the needle cage 1. In the circumferential direction, at the narrowest point of the web, the webs 3 have a width that is smaller than half the diameter of a needle roller 5. In the radial direction, a width of the flange 16 of the needle cage 1 is smaller than the diameter of a needle roller 5.

The webs 3 of the needle cage 1 have a cutout 12. The radial width of the web 3 is less than the radial width of the flange 16. However, the embodiment of FIGS. 2a-2c can be combined with the geometry of the web and of the flange of the embodiment of FIG. 1. In particular, the needle cage 1 of the embodiment of FIGS. 2a-2c may have a radial shoulder.

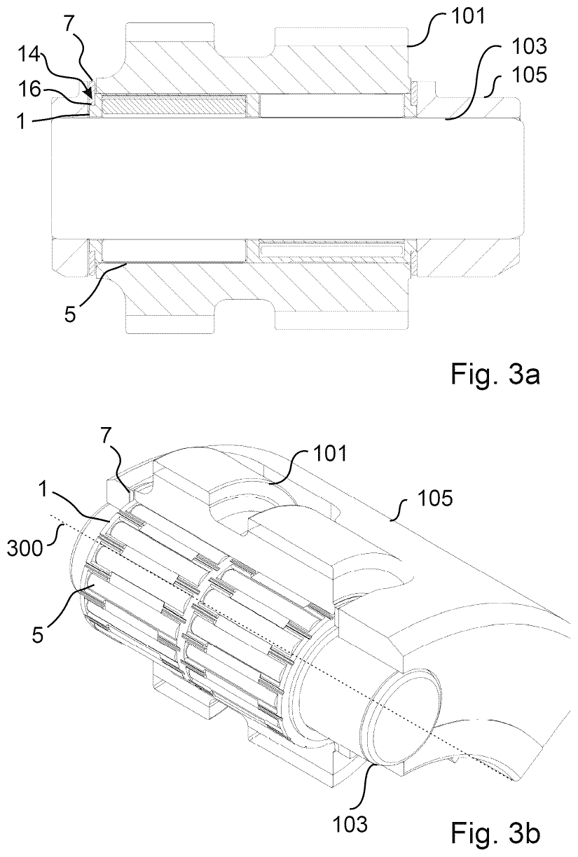

FIG. 3a shows a further embodiment of the invention. The planetary transmission comprises a double-row planet gear 101 that has two gear wheels and is fastened to the planet gear carrier 105 by way of the planet pin 103. The needle cage 1 comprises two rows of needle rollers 5. Each of the two rows of needle rollers 5 supports at least substantially one of the gear wheels. The two rows of needle rollers 5 are arranged axially one behind the other. In the embodiment of FIG. 3a, the needle cage has a one-part form, such that the two rows of needle rollers 5 are received by the needle cage 1. The webs 3 of the needle cage for the first row of needle rollers 5 are offset by half a web spacing in the direction of rotation relative to the webs 3 for the second row of needle rollers 5. A thrust washer 7 is arranged in each case on the end faces of the needle cage 1. The needle cage 1 has on its end faces in each case a radial shoulder 14 as the axial contact surface for the thrust washers 7. The radial shoulder 14 acts as an axial stop for the thrust washers 7. The thrust washers 7 lie flush on the flange 16 of the needle cage 1. The thrust washers 7 are narrower than the flanges 16 in the axial direction, but terminate flush with the end face. The needle rollers 5 therefore cannot run against the thrust washers, but only against the flanges. A double-row needle roller bearing arrangement is also possible for planet gears with only one toothing system.

FIG. 3b shows the embodiment of FIG. 3a in another illustration. The needle rollers 5 of the first row of needle rollers 5 are offset in the circumferential direction relative to the needle rollers 5 of the second row of needle rollers 5. The needle rollers are at least substantially parallel to the axis 300 of the planet gear 101 and of the planet pin 103. An axis of the needle cage is at least substantially parallel to the axis 300 of the planet gear 101 and of the planet pin 103. The thrust washers 7 are at least substantially centered around the axis 300 and rotationally symmetrical with respect to the axis 300.

FIGS. 3a and 3b show a double-row needle cage 1 that has a one-part form and has thrust washers 7 fitted thereon. In embodiments that are not shown, the double-row needle cage has a two-part form. Each of the two needle cages of the two-part double-row needle cage may have a thrust washer connected to the respective needle cage in one part, in particular as shown in the needle cages of the embodiments of FIGS. 2a-2c. In embodiments, each of the two needle cages of the two-part double-row needle cage has in each case a thrust washer fitted thereon, as shown in FIGS. 1-3b. In embodiments, the double-row needle cage has a one-part form with a first thrust washer. A second thrust washer is fitted on a flange of the double-row needle cage. The double-row needle cages of FIGS. 3a and 3b and of the embodiments not shown may have webs as in the embodiments of FIGS. 1-2c, in particular for the supply of lubricant.

1. Needle cage (1) for guiding needle rollers (5) of a needle roller bearing arrangement of a planet gear (110) of a planetary transmission on a planet gear carrier (105), the needle cage (1) comprising a flange (16),
wherein the needle cage (1) is embodied in such a way that a thrust washer (7) can be arranged on the needle cage (1) radially on the outside.

2. Needle cage (1) according to claim 1, wherein the thrust washer (7) is arranged at least substantially flush with an inner edge of a flange (16) of the needle cage (1).

3. Needle cage (1) according to claim 1, wherein the thrust washer (7) is arranged axially at least substantially flush with an end face of the needle cage (1).

4. Needle cage (1) according to claim 1, wherein webs (3) of the needle cage (1) have, in a circumferential direction, a minimum web width that is smaller than half the diameter of a needle roller (5).

5. Planetary transmission having
a planet gear (101) mounted on a planet gear carrier (105), and
a needle cage (1) for guiding needle rollers (5) of a needle roller bearing arrangement of the planet gear (101) according to claim 1,
wherein a region between the planet gear carrier (105) and the needle cage (1) is free of thrust washers.

6. Planetary transmission according to claim 5, wherein the thrust washer (7) is provided for spacing the planet gear (101) relative to the planet gear carrier (105).

7. Planetary transmission according to claim 6, wherein the thrust washer (7) and a flange (16) of the needle cage (1) overlap axially.

8. Planetary transmission according to claim 6, wherein the thrust washer (7) is arranged axially at least substantially flush with an end face of the needle cage (1).

9. Planetary transmission according to claim 6, wherein an axial spacing of the thrust washer (7) from a cheek of the planet gear carrier (105) is less than an axial spacing of an end face of the needle cage (1) from a cheek of the planet gear carrier (105).

10. Planetary transmission according to claim 5, wherein the needle cage (1) has a radial shoulder (14) as an axial contact surface of the thrust washer (7).

11. Planetary transmission according to claim 6, wherein the needle cage (1) and the thrust washer (7) have a one-part form.

12. Planetary transmission according to claim 6, wherein a second thrust washer (7) has a multi-part form with the needle cage (1).

13. Planetary transmission according to claim 6, wherein a radial inner diameter of the thrust washer (7) is smaller than a radial outer diameter of a contact surface of the thrust washer (7) on the needle cage (1).

14. Planetary transmission according to claim 5, wherein the needle cage (1) is made of a plastic, and/or wherein the thrust washer (7) is made of a hardened metal.

15. Planetary transmission according to claim 5, wherein the planetary transmission has a second needle cage for a double-row needle roller bearing arrangement.

16. Planetary transmission according to claim 15, wherein the needle cage (1) and the second needle cage each have a one-part form with in each case exactly one thrust washer (7).

17. Planetary transmission according to claim 5, wherein an axial length of the needle rollers (5) corresponds substantially to an axial width of the planet gear (101).
